(19) United States
(12) Patent Application Publication
(10) Pub. No.: US 2015/0365289 A1
(43) Pub. Date: Dec. 17, 2015

(54) ENERGY BASED NETWORK RESTRUCTURING

(71) Applicant: HEWLETT-PACKARD DEVELOPMENT COMPANY, L.P., Houston, TX (US)

(72) Inventor: Horacio Manuel Hidalgo Herrera, San Jose (CR)

(21) Appl. No.: 14/764,563

(22) PCT Filed: Mar. 15, 2013
(86) PCT No.: PCT/US2013/032063

§ 371 Date: Jul. 29, 2015

(51) Int. Cl. H04L 12/24; H04L 12/707

(52) U.S. Cl. CPC H04L 41/0833; H04L 45/22

(57) ABSTRACT

Energy based network restructuring can include retrieving a counter from a network device that is part of a network. Energy based network restructuring can also include calculating an expected load for the network device, wherein the expected load is based on a service agreement, a load history of a load on the network device, and the counter. Energy based network restructuring can include restructuring the network by allocating a network resource to the network device limited to fulfill the expected load and to reduce an energy consumption of the network device.

### BACKGROUND

In computer networking, a number of network devices can be linked through a number of communication links. The communication links can create a number of paths that data units can traverse to reach a destination. A network controller can control the number of network devices and the communication links that connect the network devices.

### BRIEF DESCRIPTION OF THE DRAWINGS

FIG. 1 is a flow chart illustrating an example of a method for energy based network restructuring according to the present disclosure.

FIG. 2 is a diagram illustrating an example of a network according to the present disclosure.

FIG. 3 is a diagram illustrating an example of an energy based network according to the present disclosure.

FIG. 4 is a diagram illustrating an example of a network controller according to the present disclosure.

### DETAILED DESCRIPTION

A network can include a number of network devices that are linked through a number of communication links. The number of network devices and the number of communication links can define a network structure. According to the basic disclosure, the network structure can change based on the energy consumption of the network. For example, the network structure can change based on the energy needs of the computing devices and/or the communication links. The energy used by the network can be reduced when the network structure is optimized to reduce the energy needs of the number of computing devices. The costs associated with maintaining a network can be reduced by reducing the energy used by the network.

As used herein, a network device can be a router, a switch, a hub, and/or computing devices such as servers, desktop PCs, laptops, workstations, and peripheral devices, e.g., printers, facsimile devices, and scanners, linked together. A network device can be a physical device and/or a virtual device. A number of network devices can be linked via communication links. Communication links can be wired and/or wireless links. Communication links can be used to receive and/or send a number of data units. Data units can include packets, frames, and/or other forms of data that originate at a source, e.g., computing device and/or network device, and are delivered to a destination, e.g., computing device and/or network device.

In a number of previous examples, network structures have not been optimized based on the energy used by the network. Ignoring the energy used by the network can lead to added network expenses as compared to network structures that are optimized to reduce the energy used by the network. In contrast, according to the present disclosure optimizing a network based on the energy used by the network can include restructuring a network based on a number of counts that are associated with the number of network devices, a number of service agreements (SA), and/or a load history of the load on each of the number of network devices.

In the present disclosure, reference is made to the accompanying drawings that form a part hereof, and in which is shown by way of illustration how a number of examples of the disclosure can be practiced. These examples are described in sufficient detail to enable those of ordinary skill in the art to practice the examples of this disclosure, and it is to be understood that other examples can be used and that process, electrical, and/or structural changes can be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

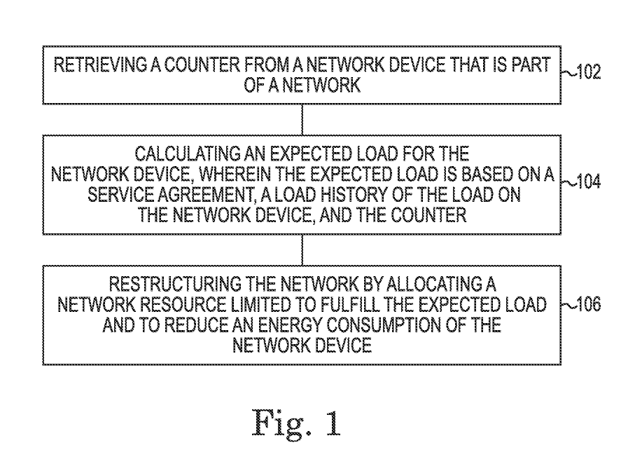

FIG. 1 is a flow chart illustrating an example of a method for energy based network restructuring according to the present disclosure. At 102, a counter is retrieved from a network device that is part of a network.

Each network device maintains a number of counters based on the data units processed. The counters can be retrieved from the application specific integrated circuit (ASIC) of the network devices. Counters can also be retrieved from machine readable instructions, e.g., software. The counters can be used to analyze a number of metrics such as jitter, data units dropped, bandwidth, latency, and/or error transmission.

Jitter can be the variance from the regularity in which data units are received, processed, and/or forwarded. Data units dropped can be the difference between the number of data units that are received and the number of data units that are forwarded. In a number of examples, bandwidth can be a measure of the data units that are processed by a network device. A network device can process data units by receiving data units, by processing data units, and by forwarding data units. Latency can be a measure of the delay in receiving, processing, and/or forwarding a number of data units. Error transmission can be a measure of the error associated in receiving, processing, and/or forwarding a number of messages. Jitter, data units dropped, bandwidth, latency, and/or error transmission can be used to analyze the current load on the networking device. A load on a network device can define the number of data units that have been received by a network device that are awaiting processing and/or that are being processed. A load can be used to determine whether a network device can receive more data units or if the network device should be assigned less data units to process that those that it is currently processing.

At 104, an expected load can be calculated for the network device, wherein the expected load is based on a service agreement (SA), a load history of the load on the network device, and the counter. A SA can define a priority and/or a bandwidth, among other standards that can be associated with data units. An SA can associate, for example, a priority with a number of data units as compared to a different priority that is associated with a number of different data units. For instance, a first data unit can be given a higher priority as compared to the priority assigned to a second data unit. A bandwidth can define the number of data units that originate from a given source and/or the number of data units that traverse a communication link and/or network device.

A load history of the load on the number of network devices can define a load that each of the number of network devices has experienced in the past. A load history of the load on the number of network devices can be used to calculate an energy consumption history of the number of network devices. A load history can be used to find trends in the traffic that is associated with the network devices. For example, a load history can be used to determine whether the bandwidth that is associated with the SAs is being used or is being exceeded.

At 106, the network can be restructured by allocating a network resource limited to fulfill the expected load and to reduce an energy consumption of the network device. A resource, e.g., a number of resources, can include communication links, processing resource, memory resources, data units, and/or energy, among other types of resources. In a number of examples, restructuring the network can include rearranging, removing, and/or adding communication links. Communication links can be rearranged, removed, and/or added when restructured configuration reduces the energy used by the network. As used here, “limited to” includes only assigning network resources that are needed to process a specific number of data units and not assigning network resources to a network device above what is needed to process the specific number of data units.

Restructuring the network can also include withholding, e.g., disassociating, network resources from a network device and/or restraining the network device from using network resources such that the network device is turned off, e.g., power down state. Restructuring the network can include assigning resources to a network device such that the network device can process a greater bandwidth of data units as compared to the bandwidth of data units that the network device was able to process before receiving the assigned resources. For example, a network device that has the capability of processing a first number of data units can be assigned network resources such that the network device can process a second number of data units and the first number of data units. Restructuring the network can also include increasing the bandwidth that is associated with a network device by a percentage of a current bandwidth sufficient to fulfill the expected loads. The bandwidth associated with a network device can increase and/or decreased based on enabled links and/or link speed. Enabled links can be communication links that are able to transmit information, e.g., active communication links. Disabled links can be communication links that cannot a transmit information, e.g., inactive communication links. In a number of examples, a disabled communication link can consume less energy than an enabled communication link. The bandwidth associated with the network device can increase by assigning other network resources to the network device.

Restructuring the network can preserve energy by limiting the resources sufficient to fulfill the expected load. For example, a network device that has the capability to process data units at a first data rate can be granted additional resources sufficient to process data units at a second data rate when the data units would have been dropped if not for the allocated resources, wherein the second data rate is greater than the first data rate. A network device that has resources sufficient to process data units at a first data rate but is only processing data units at a second data rate can be restricted of a portion of the resources such that the network device only has network resources sufficient to process data units at a second data rate, wherein the first data rate is greater than the second data rate.

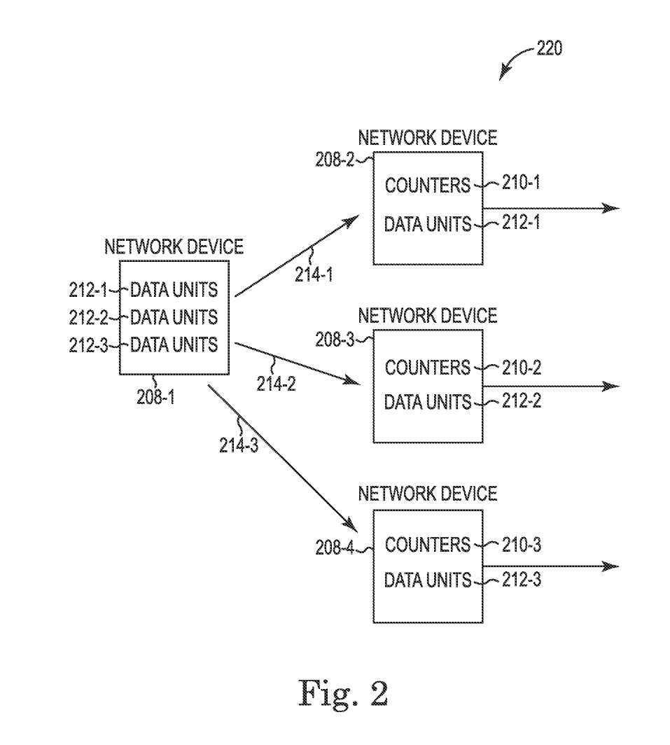

FIG. 2 is a diagram illustrating an example of a network according to the present disclosure. FIG. 2 includes a network device 208-1, a network device 208-2 with counters 210-1 and data units 212-1, a network device 208-3 with counters 210-2 and data units 212-2, and a network device 208-4 with counters 210-3 and data units 212-3, e.g., referred to generally as network devices 208. FIG. 2 also includes a communication link 214-1, a communication link 214-2, and a communication link 214-3, e.g., referred to generally as communication links 214.

Communication links 214 can link the network devices 208. For example, communication link 214-1 can link network device 208-1 to network device 208-2, communication link 214-2 can link network device 208-1 to network device 208-3, and communication link 214-3 can link network device 208-1 to network device 208-4. Data units can traverse a number of communication links

Data units 212-1, data units 212-2, and data units 212-3, e.g., referred to generally as data units 212, can be associated with a number of computing devices when a network device receives the data units and/or forwards the data units. For example, network device 208-1 can be associated with data units 212-1, data units 212-2, and data units 212-3 because the network device 208-1 received the data units 212 and because the network device 208-1 forwarded data units 212-1 to network device 208-2 through communication link 214-1, forwarded data units 212-2 to network device 208-3 through communication link 214-2, forwarded data units 212-3 to network device 208-4 through communication link 214-3.

A network controller, e.g., not illustrated, can communicate with the network devices 208 to retrieve counters 210-1, counters 210-2, and/or counters 210-3, e.g., referred to generally as counters 210. The counters 210 can be used to calculate the current energy use for each of the number of network devices. The energy that is currently used by the network devices 208 can be calculated based on the network resources that are assigned to the network devices 208 by comparing the counters 210 against the network resources that are assigned to the network devices 208.

For example, it can be determined that the network device 208-2 is using all of the network resources that are assigned to the network device 208-2 if counters 210-1 includes a data units dropped which demonstrate that data units are being received at network device 208-2 but are not being forwarded from network device 208-2. The energy used by the network device 208-2 can be calculated taking into consideration that all of the network resources that are assigned to the network device 208-2 are being used by network device 208-2.

An expected energy consumption can be calculated for each of the number of network devices 208. The expected energy consumption can be the energy that the network devices 208 are expected to use in the future. The expected energy consumption can be relative to a duration of time. For example, the expected energy consumed can be relative to a minute, an hour, and/or a day, among other durations of time. An expected energy consumption can be calculated based on an energy history of each of the number of network devices 208, the current energy consumption, and the energy requirements that the network 220 will fulfill based on the SAs.

An energy history can be based on a load history of each of the network devices 208. For example, the aggregate of the energy consumed by processing a number of data units at a number of network devices over a duration of time can be an energy history. The current energy used by the network devices 208 can be based on the counters 210 as discussed above. The energy requirements that the network 220 will fulfill can be based on the SAs. For example, an SA can include a provision indicates that the network 220 will provide a specific bandwidth over a duration of time. The energy requirements that the network 220 will fulfill based on the SAs can be calculated based on the needed resources to provide the bandwidth.

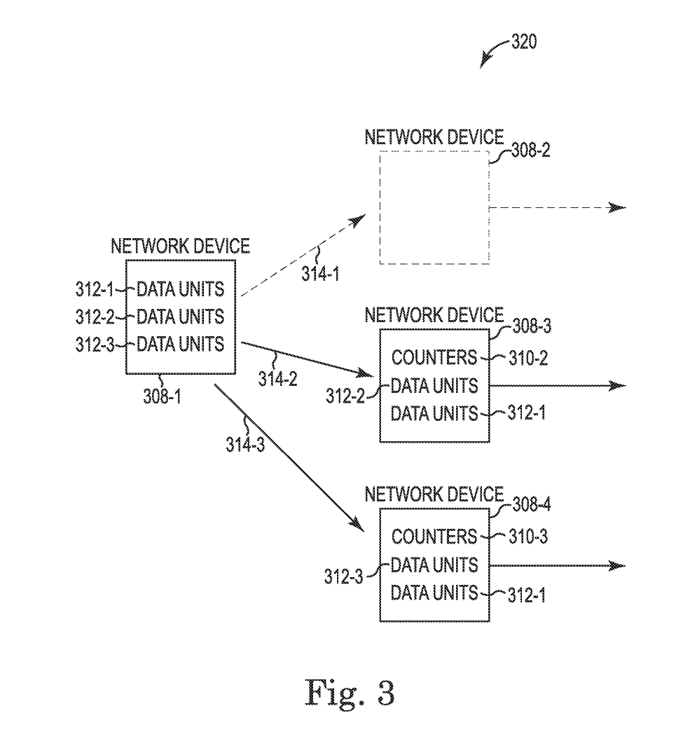

An expected energy consumption can be calculated for each of the network devices 208. The network can be restructured to reduce the energy used by the number of network devices 208, e.g., by the network 220. FIG. 3 presents an example of a restructured state of the network 220.

FIG. 3 is a diagram illustrating an example of an energy based network according to the present disclosure. FIG. 3 includes network device 308-1, network device 308-2, network device 308-3, and network device 308-4 which area analogous to network device 208-1, network device 208-2, network device 208-3, and network device 208-4 in FIG. 2, respectively, e.g., referred to generally as network devices 308. FIG. 3 also includes data units 312-1, data units 312-2, and data units 312-3 which are analogous to data units 212-1, data units 212-2, and data units 212-3 in FIG. 2, respectively. The network devices 308 are linked through communication link 314-2 and communication link 314-3 which are analogous to communication link 214-2 and communication link 214-3 in FIG. 2, respectively.

In FIG. 3, the dotted lines denote elements which were active in FIG. 2 but not active in FIG. 3. For example, network device 308-2 and communication link 314-1 are represented by dotted lines because they are not active in the network 320 as compared to network 220 in FIG. 2. In FIG. 3, network device 308-2 has been turned off by the network controller and as a result the communication link 314-1 has been removed and/or deactivated. A network device 308-2 can be turned off when all network resources are retained from network device 308-2. An off state can be an inactive state such that no energy is consumed in the off state.

As part of the restructure of network 220 in FIG. 2, the data units 212-1 that were processed by network device 208-2 in FIG. 1, have been reassigned to network device 308-3 and network device 308-4 as illustrated by the inclusion of data units 312-1 in network device 308-3 and network device 308-4. For example, in calculating the expected energy consumption of network device 208-2, network device 208-3, and network device 208-4 in FIG. 2, it can be determined that turning network device 208-2 off as illustrated in FIG. 3 with network device 308-2 and redirecting data units 312-1 to network devices 308-3 and 308-4 can reduce energy consumption.

In a number of examples, the resources that were assigned to network device 308-2 can be reduced instead of turning off network device 308-2. For example, processing resources associated with network device 308-2 can be reduced such that only a portion of the data units 312-1 are reassigned to network device 308-3 and/or network device 308-4. In a number of examples, a different network device can be added and/or activated by a network controller to network 320 and the data units 312-1 can be assigned to the different network device. In FIG. 3, the network resources 312-1 are assigned to network device 308-3 and network device 308-4 because the network devices can receive further network resources while maintaining the standards established in the SAs.

In reassigning the data units to network device 308-3 and network device 308-4, a number of other network resources can be assigned to network device 308-3 and network device 308-4. For example, processing resources that are associated with network device 308-3 and network device 308-4 can be increased sufficient to process data units 312-1, data units 312-2, and data units 312-3 without assigning network device 308-3 and network device 308-4 any other processing resources and/or other network resources that are not needed to process data units 312-1, data units 312-2, and data units 312-3. The network controller can allocate a number of network resources limited to fulfill the expected energy use of the network device 308-3, and network device 308-4 and to reduce an energy use of the network device 308-3 and network device 308-4.

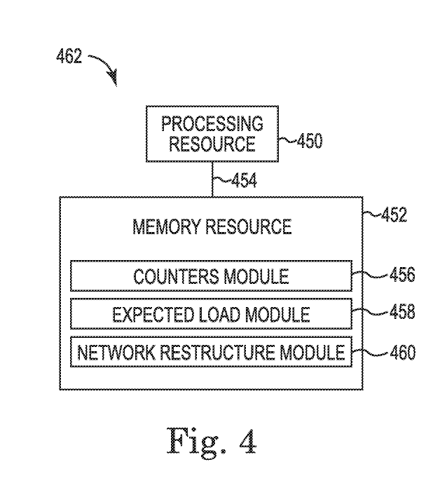

FIG. 4 is a diagram illustrating an example of a network controller according to the present disclosure. The network controller 462 can utilize software, hardware, firmware, and/or logic to perform a number of functions.

The network controller 462 can be a combination of hardware and program instructions configured to perform a number of functions, e.g., actions. The hardware, for example, can include one or more processing resources 450 and other memory resources 452, etc. The program instructions, e.g., machine-readable instructions (MRI), can include instructions stored on memory resource 452 to implement a particular function, e.g., an action such as restructuring a network.

The processing resources 450 can be in communication with the memory resource 452 storing the set of MRI executable by one or more of the processing resources 450, as described herein. The MRI can also be stored in a remote memory managed by a server and represent an installation package that can be downloaded, installed and executed. A network controller 462, e.g., server, can include memory resources 452, and the processing resources 450 can be coupled to the memory resources 452 remotely in a cloud computing environment.

Processing resources 450 can execute MRI that can be stored on internal or external non-transitory memory 452. The processing resources 450 can execute MRI to perform various functions, e.g., acts, including the functions described herein among others.

As shown in FIG. 4, the MRI can be segmented into a number of modules, e.g., a counters module 456, an expected load module 458, and a network restructure module 460, that when executed by the processing resource 450 can perform a number of functions. As used herein a module includes a set of instructions included to perform a particular task or action. The number of modules 456, 458, and 460, can be sub-modules of other modules. For example, the counter module 456 and the expected load module 458 can be sub-modules and/or contained within a single module. Furthermore, the number of modules 456, 458, and 460 can comprise individual modules separate and distinct from one another.

In the example of FIG. 4, a counters module 456 can comprise MRI that are executed by the processing resources 450 to retrieve a number of counters from a network device that is part of the network. The number of counters can be used to calculate jitter, data units dropped, bandwidth, latency, error transmission. Jitter, data units dropped, bandwidth, latency, and/or error transmission can be used to determine the current load on the network device and/or the current energy consumption of the network device.

An expected load module 458 can comprise MRI that are executed by the processing resources 450 to calculate an expected load for the network device. The expected load of the network device can be based on a number of service agreements, a load history of the load on the network device, and the number of counters.

A network restructure module 460 can comprise MRI that are executed by the processing resources 450 to restructure a number of paths that are associated with the network device limited to fulfill the expected load and to reduce an energy consumption of the network. The expected load of the network device can include a base load and a work load. A base load can define the energy that the network devices needs for the basic functions of the network device. The work load consumption can define the energy that the network device needs to process a number of data units. A base load of a first network device can identify energy that can be saved, e.g., not used, by assigning the number of data units to a second network device that has the capacity to process the number of data units. When a network device does not have a load the network device can be turned off and the communication links that are associated with the network device can be removed and/or deactivated.

In a number of examples, a number of new communication links can be associated with the network device. Additional communication links can be associated with the network device when the number of data units that the network device processes increases and when the base load plus the work load consumption are lower than a total energy capacity that is associated with the network device. A total energy capacity of a network device includes the network resources that can be assigned to the network device without affecting SA and/or without affecting the function of the network device. For example, a network device can include a processing resource that has one giga bit per second (Gbps) capacity wherein the network device has a total processor capacity of one Gbps.

A memory resource 452, as used herein, can include volatile and/or non-volatile memory. Volatile memory can include memory that depends upon power to store information, such as various types of dynamic random access memory (DRAM) among others. Non-volatile memory can include memory that does not depend upon power to store information. Examples of non-volatile memory can include solid state media such as flash memory, electrically erasable programmable read-only memory (EEPROM), phase change random access memory (PCRAM), magnetic memory such as a hard disk, tape drives, floppy disk, and/or tape memory, optical discs, digital versatile discs (DVD), Blu-ray discs (BD), compact discs (CD), and/or a solid state drive (SSD), etc., as well as other types of computer-readable media.

The memory resource 452 can be integral or communicatively coupled to a computing device in a wired and/or wireless manner. For example, the memory resource 452 can be an internal memory, a portable memory, and a portable disk, or a memory associated with another computing resource, e.g., enabling machine readable instructions (MRIs) to be transferred and/or executed across a network such as the Internet.

The memory resource 452 can be in communication with the processing resources 450 via a communication path 454. The communication path 454 can be local or remote to a machine, e.g., a computer, associated with the processing resources 450. Examples of a local communication path 454 can include an electronic bus internal to a machine, e.g., a computer, where the memory resource 452 is one of volatile, non-volatile, fixed, and/or removable storage medium in communication with the processing resources 450 via the electronic bus. Examples of such electronic buses can include Industry Standard Architecture (ISA), Peripheral Component Interconnect (PCI), Advanced Technology Attachment (ATA), Small Computer System Interface (SCSI), Universal Serial Bus (USB), among other types of electronic buses and variants thereof.

The communication path 454 can be such that the memory resource 452 is remote from a processing resource, e.g., processing resources 450, such as in a network connection between the memory resource 452 and the processing resource, e.g., processing resources 450. That is, the communication path 454 can be a network connection. Examples of such a network connection can include local area network (LAN), wide area network (WAN), personnel area network (PAN), and the Internet, among others. In such examples, the memory resource 452 can be associated with a first computing device and the processing resources 450 can be associated with a second computing device, e.g., a Java® server. For example, processing resources 450 can be in communication with a memory resource 452, wherein the memory resource 452 includes a set of instructions and wherein the processing resources 450 are designed to carry out the set of instructions.

As used herein, “logic” is an alternative or additional processing resource to perform a particular action and/or function, etc., described herein, which includes hardware, e.g., various forms of transistor logic, application specific integrated circuits (ASICs), etc., as opposed to computer executable instructions, e.g., software firmware, etc., stored in memory and executable by a processor.

As used herein, “a” or “a number of” something can refer to one or more such things. For example, “a number of widgets” can refer to one or more widgets.

The above specification, examples and data provide a description of the method and applications, and use of the system and method of the present disclosure. Since many examples can be made without departing from the spirit and scope of the system and method of the present disclosure, this specification merely sets forth some of the many possible embodiment configurations and implementations.

What is claimed:

1. A method for energy based network restructuring comprising:
retrieving a counter from a network device that is part of a network;
calculating an expected load for the network device;
wherein the expected load is based on a service agreement, a load history of a load on the network device, and the counter; and
restructuring the network by allocating a network resource to the network device limited to fulfill the expected load and to reduce an energy consumption of the network device.

2. The method of claim 1, wherein restructuring the network includes turning the network device on or off.

3. The method of claim 1, wherein restructuring the network includes reducing or increasing a bandwidth that is associated with the network device.

4. The method of claim 3, wherein reducing or increasing the bandwidth of the network device includes reducing or increasing the bandwidth by a percentage of a current bandwidth sufficient to fulfill the expected load.

5. The method of claim 1, wherein retrieving the counter includes retrieving the counter from an application specific integrated circuit (ASIC) of the network device.

6. The method of claim 5, wherein retrieving the counter includes calculating at least one of jitter, data units dropped, bandwidth, latency, and error transmission.

7. A non-transitory machine-readable medium storing instructions for energy based network restructuring executable by a machine to cause the machine to:
retrieve a counter from a network device that is part of a network;
calculate an expected energy consumption for the network device;
wherein the expected energy consumption for the network device is based on a service agreement, a load history of a load on the network device, and the counter; and
restructure the network by allocating a network resource limited to fulfill the expected energy consumption and to reduce an energy consumption of the network device.

8. The medium of claim 7, wherein the instructions executable to calculate the expected energy consumption include instructions to calculate a current energy consumption for the network device based on the counter.

9. The medium of claim 7, wherein the instructions executable to calculate the expected energy consumption include instructions to calculate an energy history of the energy consumption of the network device based on the load history of the load on the network device.

10. The medium of claim 7, wherein the instructions executable to calculate the energy consumption include instructions to calculate an energy requirement for the network to fulfill the service agreement.

11. A network controller, comprising:
a processing resource in communication with a memory resource, wherein the memory resource includes:
a counter module including instructions to retrieve a counter from a network device that is part of a network;
an expected load module including instructions to calculate an expected load for the network device;
wherein the expected load for the network device is based on a service agreement, a load history of a load on the network device, and the counter; and
a network restructure module including instructions to restructure a number of communication links that are associated with the network device limited to fulfill the expected load and to reduce an energy consumption of the network.

12. The device of claim 11, wherein the instructions to restructure the number of communication links that are associated with the network device include instructions to calculate a base load and a work load of the network device from the expected energy consumption.

13. The device of claim 12, wherein the base load defines energy needed for basic functions of the network device and wherein the work load defines energy needed by the network device to process a number of data units.

14. The system of claim 11, wherein the instructions to restructure the number of links include instructions to disassociate a link, from the number of links, from the network device and associate the link with a different network device when the different network device has a capacity to process a number of data units, wherein disassociating the link from the network device and associating the link with the different network device conserves energy.

15. The device of claim 14, wherein the instructions to restructure the number of links include instructions to associate an additional communication link with the network device when the number of data units that the network device processes increases and when the base load plus the work load are less than a total energy capacity that is associated with the network device.
